(19) United States
(12) Patent Application Publication
(10) Pub. No.: US 2017/0262116 A1
(43) Pub. Date: Sep. 14, 2017

(54) TOUCH SCAN DRIVE METHOD OF REDUCING POWER CONSUMPTION

(71) Applicant: Wuhan China Star Optoelectronics Technology Co., Ltd., Wuhan City (HB) (CN)

(72) Inventors: Qingcheng ZUO, Wuhan City (CN); Xiaoling YUAN, Wuhan City (CN)

(21) Appl. No.: 15/032,633

(22) PCT Filed: Apr. 14, 2016
(86) PCT No.: PCT/CN2016/079231

§ 371 Date: Apr. 28, 2016

(30) Foreign Application Priority Data
Mar. 8, 2016 (CN) 201610129209.7

(51) Int. Cl. G06F 3/041; G06F 3/044; G06F 1/32

(52) U.S. Cl. CPC G06F 3/0416; G06F 1/3262; G06F 3/0412; G06F 3/044

(57) ABSTRACT

The present invention provides a touch scan drive method. The discrete touch scan is implemented as the touch display panel is in the standby state or the normal display without touch state. Namely, the touch scan pulse signal is merely transmitted to a portion of the emitting electrode in one touch scan, and the signal transmission number is decreased. As the complete touch scan is implemented as the touch display panel is in the touch state, the power consumption of the touch display panel can be reduced under the premise without influencing the normal work and scan precision of the touch display panel.

### FIELD OF THE INVENTION

The present invention relates to a touch display technology field, and more particularly to a touch scan drive method of reducing power consumption.

### BACKGROUND OF THE INVENTION

With the development of the display technology, the touch control display panel has been widely applied and accepted, used by the people. For example, the smart phone, the flat panel computer and etc. all use the touch control display panel (Touch panel).

The touch display panel provides a new human machine interactive interface. The usage is more direct and convenient with fingers and a stylus for inputting.

The touch control display panels can be categorized into four types of resistive, capacitive, optics, surface acoustic wave types according to sensing technology. At present, the main stream touch control technology is the capacitive type. The capacitive type can be further categorized into self capacitive type and mutual capacitive type. The main capacitive type touch control display panel in the present market is the mutual capacitive type, and the advantage of the mutual capacitive type is being able to achieve multi-touch control. The touch display panel can be categorized according to different structures into: On cell, In Cell and Out Cell. As the competition in the smart phone markets has become increasingly fierce, the In Cell technology is considered as the high end technology of the touch display field, and possesses advantages of ultra-thin and narrow frame.

FIG. 1 is a structure diagram of a mutual capacitive touch panel, comprising a plurality of touch emitting electrodes Tx(1), Tx(2), Tx(3), . . . and Tx(m) which are horizontally aligned and a plurality of touch receiving electrodes Rx(1), Rx(2), Rx(3), . . . and Rx(n) which are vertically aligned, and both m and n are positive integers larger than 2, and the touch emitting electrodes and the touch receiving electrodes are mutually insulated. Human body carries water, which is an excellent conductor. So, if human body gets close to the electrode, the capacitance between the finger and the electrode will increase. Then, once the scan signal is transmitted to the touch emitting electrode, and the receiving electrode is controlled to receive the sense signal, the specific position of the touch point can be obtained by investigating the coordinate where the static capacity of the sense signal becomes large.

The mutual capacitive touch panel shown in FIG. 1 utilizes the time division scan, in which the touch scan is implemented after the display scan is accomplished. The sequence diagram used by the touch scan drive method of the mutual capacitive touch panel shown in FIG. 1 is now shown in FIG. 3. With combining FIG. 2 and FIG. 3, the touch scan pulse signal has to be provided line by line to all the touch emitting electrodes Tx(1), Tx(2), Tx(3), . . . and Tx(m) no matter the touch display panel is in a touch state, or in a standby state or a normal display without touch state. The signal transmission is conducted constantly for constantly detecting whether the touch is happening. For the aforesaid mutual capacitive touch panel, the signal detection is constantly conducted even in the standby state or the normal display without touch state, the touch scan signal is constantly inputted to the touch emitting electrode and constantly, there is touch receiving electrode receiving the sense signal. The electrical energy is consumed on and on to cause the waste of the power consumption.

### SUMMARY OF THE INVENTION

An objective of the present invention is to provide a touch scan drive method of reducing power consumption of the touch display panel under the premise without influencing the normal work and scan precision of the touch display panel.

For realizing the aforesaid objective, the present invention provides a touch scan drive method, comprising steps of:

step 1, providing a touch display panel;

the touch display panel comprises a plurality of touch emitting electrodes which are horizontally aligned and a plurality of touch receiving electrodes which are vertically aligned, and the touch emitting electrodes and the touch receiving electrodes are mutually insulated;

step 2, detecting and determining whether the touch display panel is in a standby state or a normal display without touch state, and if yes, executing step 3, and if no, then jumping to step 4;

step 3, implementing a row discrete touch scan, and a touch scan pulse signal is merely transmitted to a portion of the touch emitting electrodes in one touch scan, and all the touch receiving electrodes receive a touch sense signal;

for the same touch scan, at least one touch emitting electrode which stop working is between two adjacent touch emitting electrodes which are transmitted with the touch scan pulse signal; for two adjacent touch scan, the emitting electrodes transmitted with the touch scan pulse signal each time are different; continuous few times of touch scan are considered to be one unit execution cycle, and in one unit execution cycle, each touch emitting electrode at least works once;

step 4, implementing a row complete touch scan, and the touch scan pulse signal is transmitted to all the touch emitting electrodes one by one in one touch scan, and all the touch receiving electrodes receive the touch sense signal.

Selectably, N is set to be a positive integer, and a specific procedure of the discrete touch scan in the step 3 is:

the touch scan pulse signal is merely transmitted to all the odd touch emitting electrodes in the Nth touch scan, and all the even touch receiving electrodes stop working;

the touch scan pulse signal is merely transmitted to all the even touch emitting electrodes in the N+1th touch scan, and all the odd touch receiving electrodes stop working.

M is set to be an integer larger than or equal to 2, and continuous M touch scans are considered to be one unit execution cycle, and in one unit execution cycle, each touch emitting electrode at least works once.

In the discrete touch scan, a timing difference of the two adjacent touch scan pulse signals is a width of two pulses.

Selectably, N is set to be a positive integer, and i is an positive integer, and a specific procedure of the discrete touch scan in the step 3 is:

the touch scan pulse signal is merely transmitted to all the 3i-2th touch emitting electrodes in the Nth touch scan, and the other touch receiving electrodes stop working;

the touch scan pulse signal is merely transmitted to all the 3i-1th touch emitting electrodes in the N+1th touch scan, and the other touch receiving electrodes stop working;

the touch scan pulse signal is merely transmitted to all the 3ith touch emitting electrodes in the N+2th touch scan, and the other touch receiving electrodes stop working.

M is set to be an integer larger than or equal to 3, and continuous M touch scans are considered to be one unit execution cycle, and in one unit execution cycle, each touch emitting electrode at least works once.

In the discrete touch scan, a timing difference of the two adjacent touch scan pulse signals is a width of three pulses.

In the complete touch scan, a timing difference of the two adjacent touch scan pulse signals is a width of one pulse.

The touch display panel is an In Cell type Mutual-capacitive touch display panel.

The present invention further provides a touch scan drive method of reducing power consumption, comprising steps of:

step 1, providing a touch display panel;

the touch display panel comprises a plurality of touch emitting electrodes which are horizontally aligned and a plurality of touch receiving electrodes which are vertically aligned, and the touch emitting electrodes and the touch receiving electrodes are mutually insulated;

step 2, detecting and determining whether the touch display panel is in a standby state or a normal display without touch state, and if yes, executing step 3, and if no, then jumping to step 4;

step 3, implementing a row discrete touch scan, and a touch scan pulse signal is merely transmitted to a portion of the touch emitting electrodes in one touch scan, and all the touch receiving electrodes receive a touch sense signal;

for the same touch scan, at least one touch emitting electrode which stop working is between two adjacent touch emitting electrodes which are transmitted with the touch scan pulse signal; for two adjacent touch scan, the emitting electrodes transmitted with the touch scan pulse signal each time are different; continuous few times of touch scan are considered to be one unit execution cycle, and in one unit execution cycle, each touch emitting electrode at least works once;

step 4, implementing a row complete touch scan, and the touch scan pulse signal is transmitted to all the touch emitting electrodes one by one in one touch scan, and all the touch receiving electrodes receive the touch sense signal;

wherein the touch display panel is an In Cell type Mutual-capacitive touch display panel;

wherein in the complete touch scan, a timing difference of the two adjacent touch scan pulse signals is a width of one pulse.

The benefits of the present invention is: in the touch scan drive method provided by the present invention, the discrete touch scan is implemented as the touch display panel is in the standby state or the normal display without touch state. Namely, the touch scan pulse signal is merely transmitted to a portion of the emitting electrode in one touch scan, and the signal transmission number is decreased. As the complete touch scan is implemented as the touch display panel is in the touch state, the power consumption of the touch display panel can be reduced under the premise without influencing the normal work and scan precision of the touch display panel.

### BRIEF DESCRIPTION OF THE DRAWINGS

In order to better understand the characteristics and technical aspect of the invention, please refer to the following detailed description of the present invention is concerned with the diagrams, however, provide reference to the accompanying drawings and description only and is not intended to be limiting of the invention.

In drawings,

FIG. 1 is a structure diagram of a mutual capacitive touch panel;

FIG. 2 is a working condition diagram of a touch emitting electrode in a touch scan drive method according to prior art;

FIG. 3 is a sequence diagram of a touch scan drive method according to prior art;

FIG. 4 is a flowchart of a touch scan drive method of reducing power consumption according to the present invention;

FIG. 5 is a working condition diagram of a touch emitting electrode in the Nth touch scan according to one embodiment of the step 3 in the touch scan drive method of reducing power consumption according to the present invention;

FIG. 6 is a sequence corresponding to FIG. 5;

FIG. 7 is a working condition diagram of a touch emitting electrode in the N+1th touch scan according to one embodiment of the step 3 in the touch scan drive method of reducing power consumption according to the present invention;

FIG. 8 is a sequence corresponding to FIG. 7;

FIG. 9 is a working condition diagram of a touch emitting electrode in the step 4 in the touch scan drive method of reducing power consumption according to the present invention;

FIG. 10 is a sequence corresponding to FIG. 9.

### DETAILED DESCRIPTION OF PREFERRED EMBODIMENTS

For better explaining the technical solution and the effect of the present invention, the present invention will be further described in detail with the accompanying drawings and the specific embodiments.

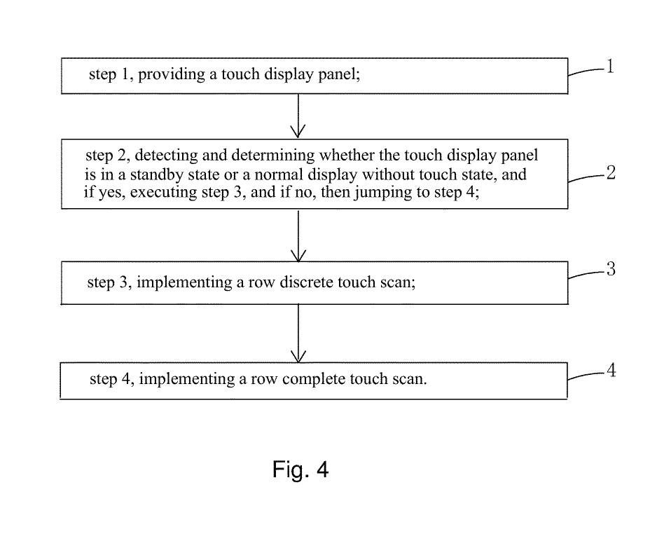

Please refer to FIG. 4. The present invention provides a touch scan drive method of reducing power consumption comprising steps of:

step 1, providing a touch display panel.

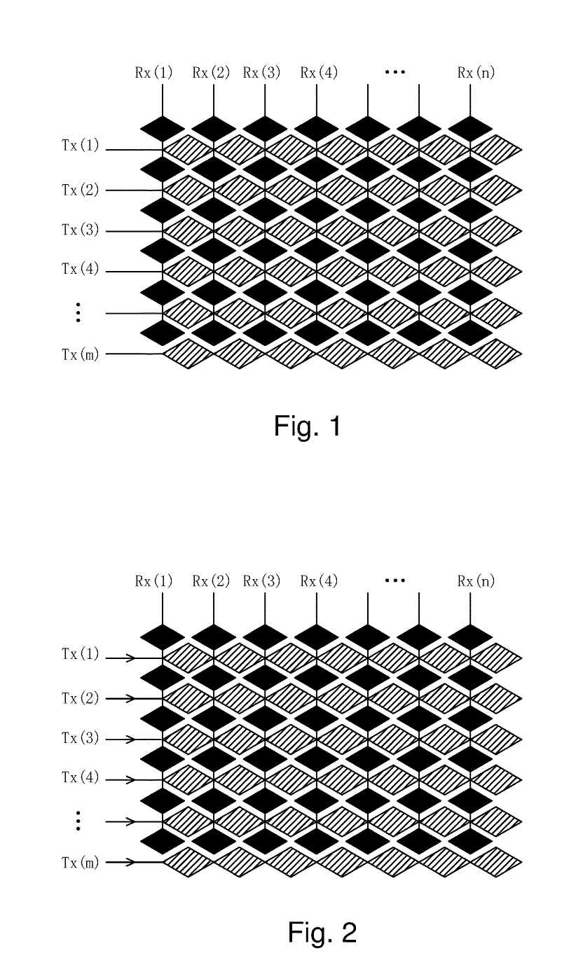

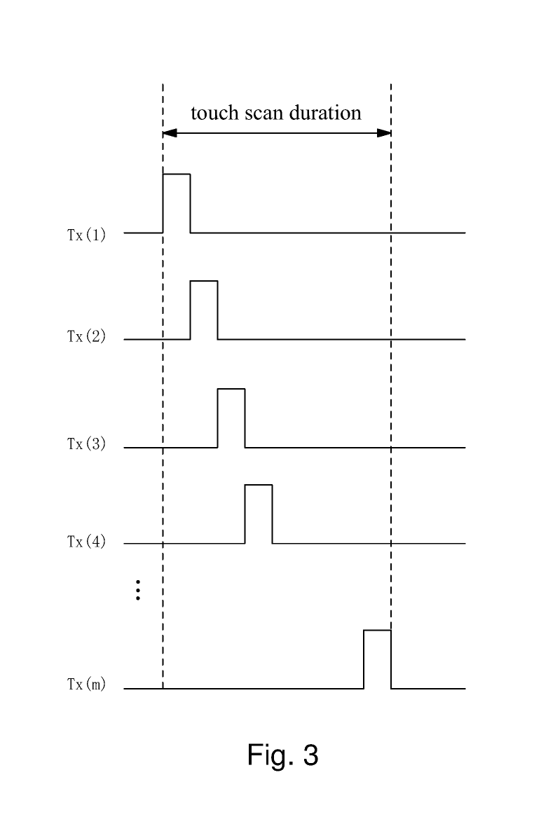

Preferably, the touch display panel is an In Cell type Mutual-capacitive touch display panel, and as shown in FIG. 1, comprising a plurality of touch emitting electrodes Tx(1), Tx(2), Tx(3), . . . and Tx(m) which are horizontally aligned and a plurality of touch receiving electrodes Rx(1), Rx(2), Rx(3), . . . and Rx(n) which are vertically aligned, and both m and n are positive integers larger than 2, and the touch emitting electrodes and the touch receiving electrodes are mutually insulated.

The touch emitting electrodes Tx(1), Tx(2), Tx(3), . . . and Tx(m) are employed to transmit the touch scan pulse signal, and the touch receiving electrodes Rx(1), Rx(2), Rx(3), . . . and Rx(n) are employed to receive the touch sense signal.

step 2, detecting and determining whether the touch display panel is in a standby state or a normal display without touch state, and if yes, executing step 3, and if no, then jumping to step 4.

step 3, implementing a discrete touch scan.

The discrete touch scan means that the touch scan pulse signal is merely transmitted to a portion of the touch emitting electrodes in one touch scan, and all the touch receiving electrodes Rx(1), Rx(2), Rx(3), . . . and Rx(n) receive the touch sense signal; for the same touch scan, at least one touch emitting electrode which stop working is between two adjacent touch emitting electrodes which are transmitted with the touch scan pulse signal; for two adjacent touch scan, the emitting electrodes transmitted with the touch scan pulse signal each time are different; continuous few times of touch scan are considered to be one unit execution cycle, and in one unit execution cycle, each touch emitting electrode at least works once.

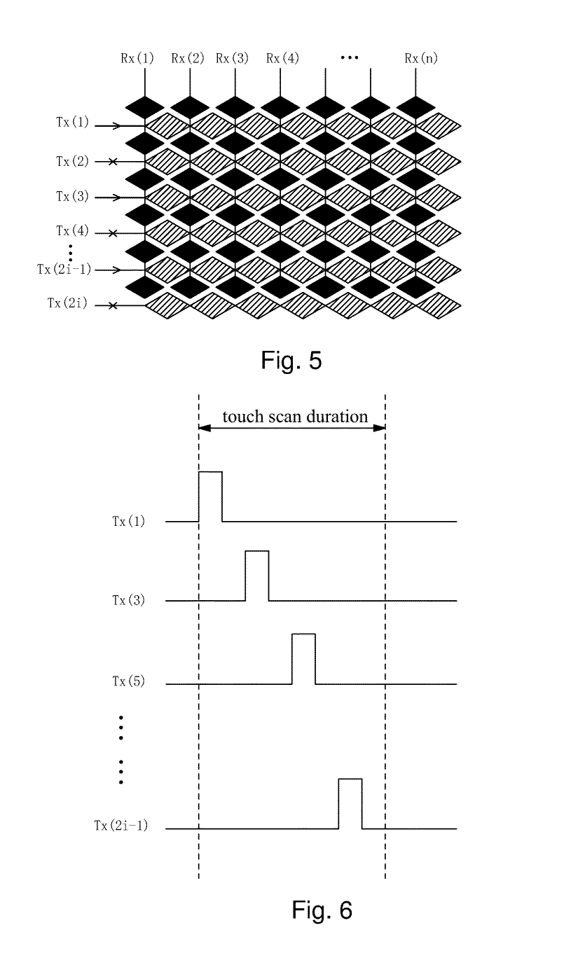

Many embodiments can be illustrated for the discrete touch scan. Please refer to FIG. 5 to FIG. 8, N is set to be a positive integer, and i is an positive integer, and a specific procedure of the discrete touch scan can be:

As shown in FIG. 5, the touch scan pulse signal is merely transmitted to all the odd touch emitting electrodes, i.e all the 2i-1th touch emitting electrodes Tx(1), Tx(3), Tx(5), Tx(7), and etc in the Nth touch scan, and all the even touch receiving electrodes, i.e. all the 2ith touch emitting electrodes Tx(2), Tx(4), Tx(6), Tx(8), and etc stop working. The timing difference of the two adjacent touch scan pulse signals a width of two pulses as shown in FIG. 6.

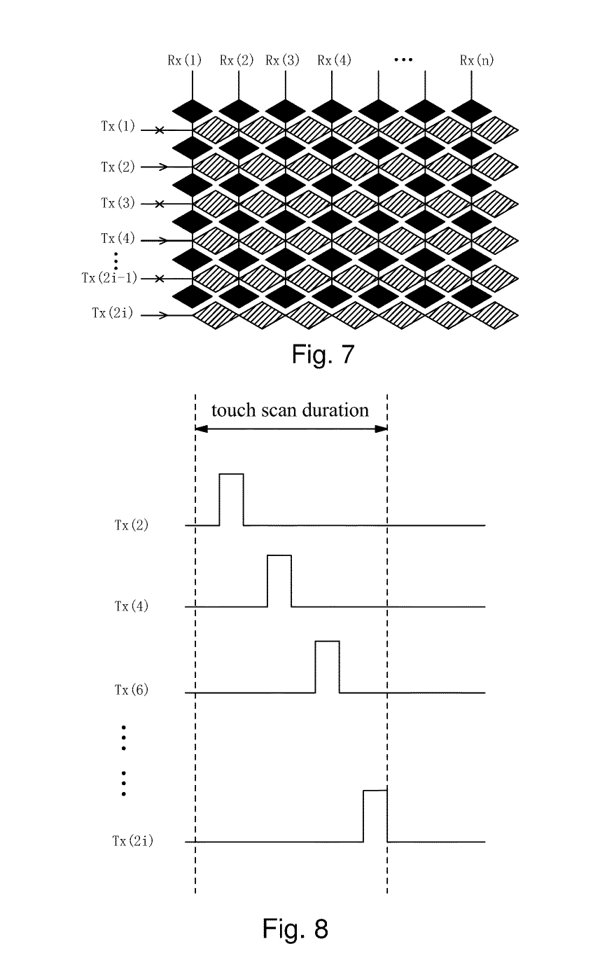

As shown in FIG. 7, the touch scan pulse signal is merely transmitted to all the even touch receiving electrodes, i.e. all the 2ith touch emitting electrodes Tx(2), Tx(4), Tx(6), Tx(8), and etc in the N+1th touch scan, and all the odd touch emitting electrodes, i.e all the 2i-1th touch emitting electrodes Tx(1), Tx(3), Tx(5), Tx(7), and etc stop working. The timing difference of the two adjacent touch scan pulse signals a width of two pulses as shown in FIG. 8.

M is set to be an integer larger than or equal to 2, and continuous M touch scans are considered to be one unit execution cycle, and in one unit execution cycle, each touch emitting electrode at least works once. Namely, after the touch scans of 2 times or more than 2 times, all the touch emitting electrodes Tx(1), Tx(2), Tx(3), . . . and Tx(m) are scanned.

In comparison with the touch scan drive method according to prior art that the touch scan pulse signal are still provided line by line to all the touch emitting electrodes Tx(1), Tx(2), Tx(3), . . . and Tx(m) as the touch display panel is in the standby state or the normal display without touch state, the discrete touch scan manner decreases the signal transmission amount of one touch scan down to ½ as the touch display panel is in the standby state or the normal display without touch state, and thus, the power consumption can be reduced.

Similarly, N is set to be a positive integer, and i is an positive integer, and a specific procedure of the discrete touch scan also can be:

the touch scan pulse signal is merely transmitted to all the 3i-2th touch emitting electrodes Tx(1), Tx(4), Tx(7), Tx(10), and etc in the Nth touch scan, and the other touch receiving electrodes stop working;

the touch scan pulse signal is merely transmitted to all the 3i-1th touch emitting electrodes Tx(2), Tx(5), Tx(8), Tx(11), and etc in the N+1th touch scan, and the other touch receiving electrodes stop working;

the touch scan pulse signal is merely transmitted to all the 3ith touch emitting electrodes Tx(3), Tx(6), Tx(9), Tx(12), and etc in the N+2th touch scan, and the other touch receiving electrodes stop working. In such manner of discrete touch scan, a timing difference of the two adjacent touch scan pulse signals is a width of three pulses.

M is set to be an integer larger than or equal to 3, and continuous M touch scans are considered to be one unit execution cycle, and in one unit execution cycle, each touch emitting electrode at least works once. Namely, after the touch scans of 3 times or more than 3 times, all the touch emitting electrodes Tx(1), Tx(2), Tx(3), . . . and Tx(m) are scanned.

In comparison with the touch scan drive method according to prior art that the touch scan pulse signal are still provided line by line to all the touch emitting electrodes Tx(1), Tx(2), Tx(3), . . . and Tx(m) as the touch display panel is in the standby state or the normal display without touch state, the discrete touch scan manner decreases the signal transmission amount of one touch scan down to ⅔ as the touch display panel is in the standby state or the normal display without touch state, and thus, the power consumption can be reduced.

step 4, implementing a complete touch scan.

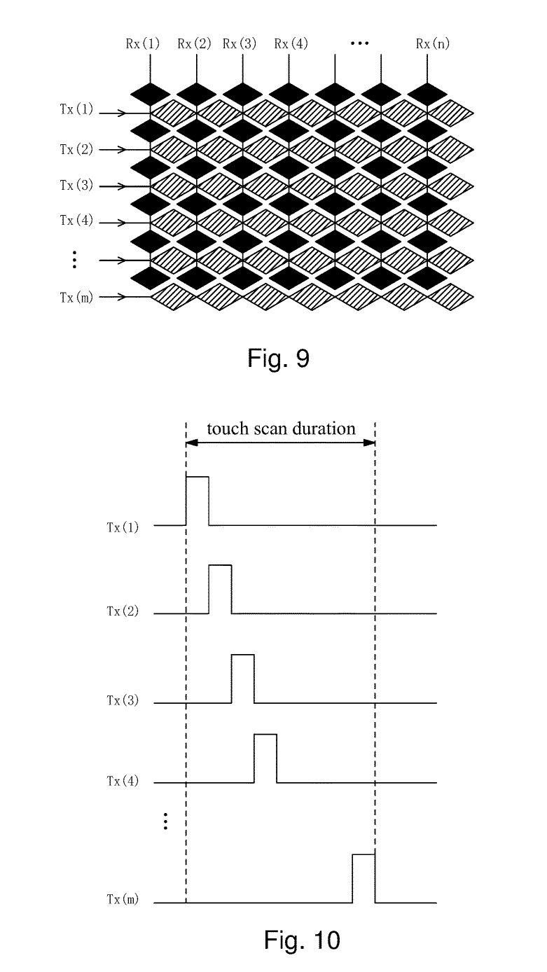

As shown in FIG. 9, the complete touch scan means that the touch scan pulse signal is transmitted to all the touch emitting electrodes Tx(1), Tx(2), Tx(3), . . . and Tx(m) one by one in one touch scan, and all the touch receiving electrodes Rx(1), Rx(2), Rx(3), . . . and Rx(n) receive the touch sense signal. As shown in FIG. 10, in the complete touch scan, a timing difference of the two adjacent touch scan pulse signals is a width of one pulse.

In the touch state, the step 4 implements the complete touch scan, which can obtain the specific position of the touch point accurately. Therefore, the normal work and scan precision of the touch display panel will not be influenced.

In conclusion, in the touch scan drive method of the present invention, the discrete touch scan is implemented as the touch display panel is in the standby state or the normal display without touch state. Namely, the touch scan pulse signal is merely transmitted to a portion of the emitting electrode in one touch scan, and the signal transmission number is decreased. As the complete touch scan is implemented as the touch display panel is in the touch state, the power consumption of the touch display panel can be reduced under the premise without influencing the normal work and scan precision of the touch display panel.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A touch scan drive method of reducing power consumption, comprising steps of:
step 1, providing a touch display panel;
the touch display panel comprises a plurality of touch emitting electrodes which are horizontally aligned and a plurality of touch receiving electrodes which are vertically aligned, and the touch emitting electrodes and the touch receiving electrodes are mutually insulated;
step 2, detecting and determining whether the touch display panel is in a standby state or a normal display without touch state, and if yes, executing step 3, and if no, then jumping to step 4;
step 3, implementing a row discrete touch scan, and a touch scan pulse signal is merely transmitted to a portion of the touch emitting electrodes in one touch scan, and all the touch receiving electrodes receive a touch sense signal;
for the same touch scan, at least one touch emitting electrode which stop working is between two adjacent touch emitting electrodes which are transmitted with the touch scan pulse signal; for two adjacent touch scan, the emitting electrodes transmitted with the touch scan pulse signal each time are different; continuous few times of touch scan are considered to be one unit execution cycle, and in one unit execution cycle, each touch emitting electrode at least works once;
step 4, implementing a row complete touch scan, and the touch scan pulse signal is transmitted to all the touch emitting electrodes one by one in one touch scan, and all the touch receiving electrodes receive the touch sense signal.

2. The touch scan drive method of reducing power consumption according to claim 1, wherein N is set to be a positive integer, and a specific procedure of the discrete touch scan in the step 3 is:
the touch scan pulse signal is merely transmitted to all the odd touch emitting electrodes in the Nth touch scan, and all the even touch receiving electrodes stop working;
the touch scan pulse signal is merely transmitted to all the even touch emitting electrodes in the N+1th touch scan, and all the odd touch receiving electrodes stop working.

3. The touch scan drive method of reducing power consumption according to claim 2, wherein M is set to be an integer larger than or equal to 2, and continuous M touch scans are considered to be one unit execution cycle, and in one unit execution cycle, each touch emitting electrode at least works once.

4. The touch scan drive method of reducing power consumption according to claim 3, wherein in the discrete touch scan, a timing difference of the two adjacent touch scan pulse signals is a width of two pulses.

5. The touch scan drive method of reducing power consumption according to claim 1, wherein N is set to be a positive integer, and i is a positive integer, and a specific procedure of the discrete touch scan in the step 3 is:
the touch scan pulse signal is merely transmitted to all the 3i-2th touch emitting electrodes in the Nth touch scan, and the other touch receiving electrodes stop working;
the touch scan pulse signal is merely transmitted to all the 3i-1th touch emitting electrodes in the N+1th touch scan, and the other touch receiving electrodes stop working;
the touch scan pulse signal is merely transmitted to all the 3ith touch emitting electrodes in the N+2th touch scan, and the other touch receiving electrodes stop working.

6. The touch scan drive method of reducing power consumption according to claim 5, wherein M is set to be an integer larger than or equal to 3, and continuous M touch scans are considered to be one unit execution cycle, and in one unit execution cycle, each touch emitting electrode at least works once.

7. The touch scan drive method of reducing power consumption according to claim 6, wherein in the discrete touch scan, a timing difference of the two adjacent touch scan pulse signals is a width of three pulses.

8. The touch scan drive method of reducing power consumption according to claim 1, wherein in the complete touch scan, a timing difference of the two adjacent touch scan pulse signals is a width of one pulse.

9. The touch scan drive method of reducing power consumption according to claim 1, wherein the touch display panel is an In Cell Mutual-capacitive touch display panel.

10. A touch scan drive method of reducing power consumption, comprising steps of:
step 1, providing a touch display panel;
the touch display panel comprises a plurality of touch emitting electrodes which are horizontally aligned and a plurality of touch receiving electrodes which are vertically aligned, and the touch emitting electrodes and the touch receiving electrodes are mutually insulated;
step 2, detecting and determining whether the touch display panel is in a standby state or a normal display without touch state, and if yes, executing step 3, and if no, then jumping to step 4;
step 3, implementing a row discrete touch scan, and a touch scan pulse signal is merely transmitted to a portion of the touch emitting electrodes in one touch scan, and all the touch receiving electrodes receive a touch sense signal;
for the same touch scan, at least one touch emitting electrode which stop working is between two adjacent touch emitting electrodes which are transmitted with the touch scan pulse signal; for two adjacent touch scan, the emitting electrodes transmitted with the touch scan pulse signal each time are different; continuous few times of touch scan are considered to be one unit execution cycle, and in one unit execution cycle, each touch emitting electrode at least works once;
step 4, implementing a row complete touch scan, and the touch scan pulse signal is transmitted to all the touch emitting electrodes one by one in one touch scan, and all the touch receiving electrodes receive the touch sense signal;
wherein the touch display panel is an In Cell type Mutual-capacitive touch display panel;
wherein in the complete touch scan, a timing difference of the two adjacent touch scan pulse signals is a width of one pulse.

11. The touch scan drive method of reducing power consumption according to claim 10, wherein N is set to be a positive integer, and a specific procedure of the discrete touch scan in the step 3 is:
the touch scan pulse signal is merely transmitted to all the odd touch emitting electrodes in the Nth touch scan, and all the even touch receiving electrodes stop working;
the touch scan pulse signal is merely transmitted to all the even touch emitting electrodes in the N+1th touch scan, and all the odd touch receiving electrodes stop working.

12. The touch scan drive method of reducing power consumption according to claim 11, wherein M is set to be an integer larger than or equal to 2, and continuous M touch scans are considered to be one unit execution cycle, and in one unit execution cycle, each touch emitting electrode at least works once.

13. The touch scan drive method of reducing power consumption according to claim 12, wherein in the discrete touch scan, a timing difference of the two adjacent touch scan pulse signals is a width of two pulses.

14. The touch scan drive method of reducing power consumption according to claim 10, wherein N is set to be a positive integer, and i is a positive integer, and a specific procedure of the discrete touch scan in the step 3 is:
the touch scan pulse signal is merely transmitted to all the 3i-2th touch emitting electrodes in the Nth touch scan, and the other touch receiving electrodes stop working;
the touch scan pulse signal is merely transmitted to all the 3i-1th touch emitting electrodes in the N+1th touch scan, and the other touch receiving electrodes stop working;
the touch scan pulse signal is merely transmitted to all the 3ith touch emitting electrodes in the N+2th touch scan, and the other touch receiving electrodes stop working.

15. The touch scan drive method of reducing power consumption according to claim 14, wherein M is set to be an integer larger than or equal to 3, and continuous M touch scans are considered to be one unit execution cycle, and in one unit execution cycle, each touch emitting electrode at least works once.

16. The touch scan drive method of reducing power consumption according to claim 15, wherein in the discrete touch scan, a timing difference of the two adjacent touch scan pulse signals is a width of three pulses.
